(19) United States
(12) Patent Application Publication
(10) Pub. No.: US 2009/0109809 A1
(43) Pub. Date: Apr. 30, 2009

(54) LASER DRIVE DEVICE AND INFORMATION RECORDING/REPRODUCING APPARATUS USING THE DEVICE

(75) Inventors: Kazuto Kuroda, Yokohama-shi (JP); Kazuo Watabe, Yokohama-shi (JP); Keiichiro Yusu, Yokohama-shi (JP); Chosaku Noda, Yokohama-shi (JP); Nobuaki Kaji, Yokohama-shi (JP); Takashi Usui, Yokohama-shi (JP); Masahiro Saito, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/258,359

(22) Filed: Oct. 24, 2008

(30) Foreign Application Priority Data
Oct. 26, 2007 (JP) 2007-279264

(51) Int. Cl. G11B 7/00

(52) U.S. Cl. 369/44.23; G9B/7

(57) ABSTRACT

According to one embodiment, a laser drive circuit includes a photodetector which receives part of laser light emitted from a laser element to a recording medium independently of reflection laser light reflected by the recording medium, and outputs an output corresponding to the strength thereof, an integration circuit which integrates the output from the photodetector for a predetermined time, and a setting circuit which sets the intensity of a laser drive current supplied to the laser element on the basis of the output from the integration circuit.

### CROSS-REFERENCE TO RELATED APPLICATIONS

This application is based upon and claims the benefit of priority from Japanese Patent Application No. 2007-279264, filed Oct. 26, 2007, the entire contents of which are incorporated herein by reference.

### BACKGROUND

1. Field

One embodiment of the present invention relates to an information recording/reproducing apparatus for recording information on a recording medium using sub-nanosecond class pulse laser light with a low duty ratio (the ratio of laser light irradiation time to a recording mark length), and it also relates to a laser drive device for use in such apparatus.

2. Description of the Related Art

A DVD compliant with a digital versatile disc (DVD) standard has been in wide use as an optical disc for storing digital images. As an optical disc having larger capacity than the above-mentioned DVD (referred to as an existing DVD), an HD DVD which is a further development of the DVD standard has also been already in wide use.

As a method of recording on such optical discs, there has been developed a method of recording information at higher density using a sharp recording pulse having a length smaller than 1 ns. This recording method is called, for example, a sub-nanosecond pulse recording method, or a recording method using a relaxation oscillation.

For example, Japanese Patent Application Publication (KOKAI) No. 2005-129832 has disclosed averaging by a low-pass filter and detecting the output of high-velocity short pulse light in which the pulse length of a drive current is 2 to 15 ns and in which a repetition period is about 3 to 30 ns.

For example, Japanese Patent Application Publication (KOKAI) No. Hei 6-89438 has disclosed detecting reflection light (reproduction waveform) from an optical disc and setting laser power for recording.

However, the methods described in both the documents do not accurately find the power of short pulse laser light having a duty ratio (the ratio of emission time of a laser element to a recording mark length) of about 10% for the reasons including the following:

a) The response of a monitor photoelectric conversion element is slower than a pulse, and it is difficult to acquire the instantaneous value;

b) The duty ratio of a pulse is low, so that an average value with respect to peak power is small, and the signal-to-noise ratio of the average value decreases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information reproducing apparatus (an optical disc apparatus) according to an embodiment of the invention;

FIGS. 2A to 2F are exemplary diagrams each showing an example of the relation between the output of a monitoring detector and the energy amount of laser light in the optical disc apparatus shown in FIG. 1, according to an embodiment of the invention;

FIG. 3 is an exemplary diagram showing an example of a laser drive circuit (laser modulation control circuit) used in the optical disc apparatus shown in FIG. 1, according to an embodiment of the invention;

FIG. 4 is an exemplary diagram showing an example of an offset detection flow (routine) using the laser drive circuit (laser modulation control circuit) shown in FIG. 3, according to an embodiment of the invention;

FIG. 5A is an exemplary diagram showing an example of the relation between the output of a pre-integrator and the input to a post-integrator with regard to the offset detection shown in FIG. 4, according to an embodiment of the invention;

FIG. 5B is an exemplary diagram showing an example of the integration time of the offset detection shown in FIG. 4, according to an embodiment of the invention;

FIGS. 6A to 6C are exemplary diagrams each showing an example of the relation between the output of the pre-integrator and the input to the post-integrator with regard to the offset detection shown in FIG. 4, according to an embodiment of the invention;

FIG. 7 is an exemplary diagram showing an example of a resonator length of a laser element (a laser unit) used in the optical disc apparatus shown in FIG. 1, according to an embodiment of the invention;

FIGS. 8A to 8D are exemplary diagrams each showing an example of the relation between light emission of the laser element and a laser drive current of the optical disc apparatus shown in FIG. 7, according to an embodiment of the invention;

FIG. 9 is an exemplary diagram showing an example of an output waveform of laser light output from the laser element of the optical disc apparatus shown in FIG. 7, according to an embodiment of the invention;

FIG. 10 is an exemplary diagram showing an example of the relation among a drive current supplied to the laser element, a laser output waveform, and (the formation process of) a recording mark formed in a recording film in the optical disc apparatus shown in FIG. 7, according to an embodiment of the invention;

FIG. 11 is an exemplary diagram showing an example of the relation between the laser output waveform and a “T1” period of the optical disc apparatus shown in FIG. 10, according to an embodiment of the invention;

FIG. 12 is an exemplary diagram showing an example of the relation of the laser output waveform with the length of a section (C) in the optical disc apparatus shown in FIG. 10, according to an embodiment of the invention; and

FIG. 13 is an exemplary diagram showing an example of the relation between data (NRZI) recorded using sub-nanosecond pulse recording of the present embodiment and a corresponding drive current waveform of the laser element, in an information reproducing apparatus (an optical disc apparatus) according to an embodiment of the invention.

### DETAILED DESCRIPTION

Various embodiments according to the invention will be described hereinafter with reference to the accompanying drawings. In general, according to one embodiment of the invention, a laser drive circuit includes a photodetector which receives part of laser light emitted from a laser element to a recording medium independently of reflection laser light reflected by the recording medium, and outputs an output corresponding to the strength thereof, an integration circuit which integrates the output from the photodetector for a predetermined time, and a setting circuit which sets the intensity of a laser drive current supplied to the laser element on the basis of the output from the integration circuit.

Embodiments of this invention will be described in detail with reference to the drawings.

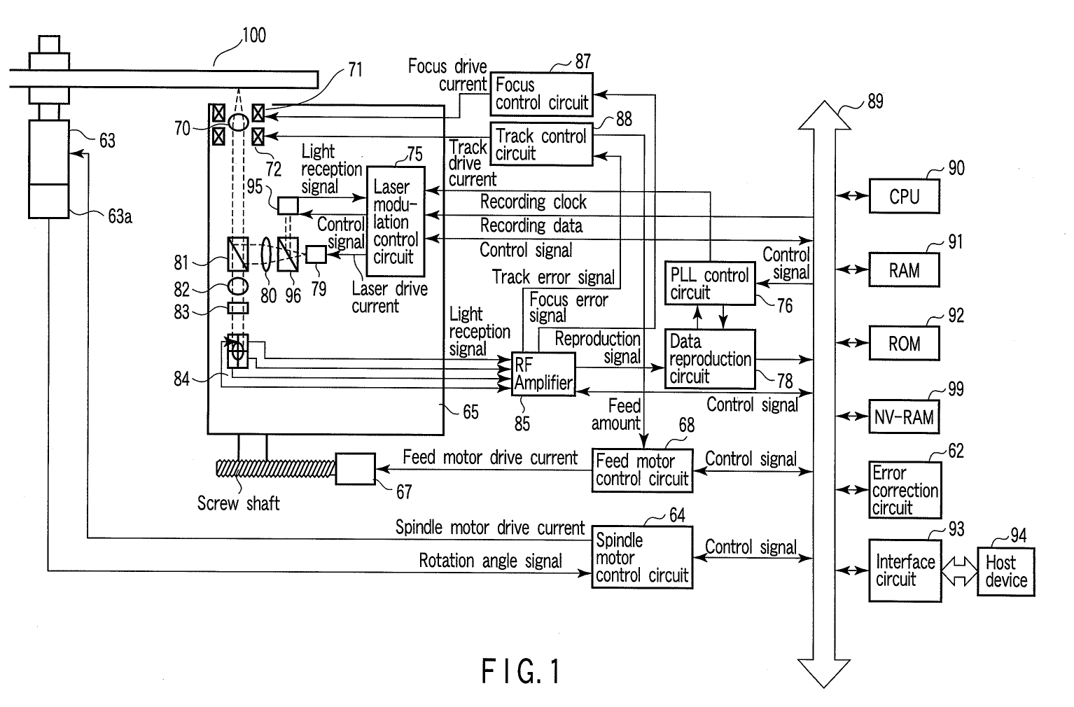

FIG. 1 is a block diagram showing one example of the configuration of an information recording/reproducing apparatus (optical disc drive) to which the present invention is applicable.

The information recording/reproducing apparatus (optical disc drive) records information in a recording surface of an information recording medium (optical disc) 100 or reproduces information recorded in the recording surface.

A concentric or spiral groove is cut in the recording surface of the optical disc 100. A concave portion of the groove is called a land while a convex portion of the groove is called a groove, and one round of the groove or land is called a track.

Laser light whose strength has been modulated is applied along the track (the groove alone or the groove and land) to form a recording mark, such that user data is recorded. The reproduction of the data is achieved by applying laser light of read power weaker than that in recording along the track and thereby detecting a change in the strength of light reflected by the recording mark on the track.

The erasure of recorded data can be achieved by applying laser light of erase power stronger than that of the read power along the track and thereby crystallizing a recording layer.

The optical disc 100 is rotated at a predetermined velocity by a spindle motor 63.

A rotation angle signal is output from a rotary encoder 63A provided in the spindle motor 63. One rotation of the spindle motor 63 produces, for example, five pulses of the rotation angle signal. By this rotation angle signal, a spindle motor control circuit 64 judges the rotation angle and rotation number of the spindle motor 63.

The recording of information on the optical disc 100 and the reproduction of information from the optical disc 100 are achieved by an optical pickup (hereinafter, a pickup head, PUH) 65.

The PUH 65 is coupled to a feed motor 67 via a gear and a screw shaft. The feed motor 67 is controlled by a feed motor control circuit 68. The feed motor 67 is rotated by a feed motor drive current from the feed motor control circuit 68, such that the optical head 65 moves in the radial direction of the optical disc 100.

The PUH 65 is provided with an objective lens 70 which is supported by an unshown wire or leaf spring to be movable over a predetermined distance in a direction perpendicular to the recording surface of the optical disc 100 or in the radial direction of the optical disc 100. The objective lens 70 can be moved in a focusing direction (the direction perpendicular to the recording surface, i.e., the optical axis direction of the objective lens 70) by the driving of a drive coil 72, and can also be moved in a tracking direction (the radial direction of the optical disc 100, i.e., a direction perpendicular to the optical axis of the objective lens 70) by the driving of a drive coil 71.

In recording information (the formation of a mark), a laser modulation control circuit 75 supplies a write signal to a laser diode (laser light emitting element) 79 on the basis of recording data supplied from a host device 94 via an interface circuit 93.

The laser light generated by the laser diode 79 enters a half-mirror 96. The half-mirror 96 branches the laser light generated by the laser diode 79 by a fixed ratio.

A monitor light detector (FM-PD) 95 configured by a photodiode receives part of the laser light from the half-mirror 96. The monitor light detector (FM-PD) 95 detects part of the laser light proportionate to irradiation power, and supplies a light reception signal to the laser modulation control circuit 75.

The laser modulation control circuit 75 controls the laser diode 79 on the basis of the strength of reflection laser light received by the monitor light detector 95 so that reproduction laser power, recording laser power and erase laser power that have been set by a main arithmetic processing block 90 including a central processing unit (CPU) may be suitably obtained.

The laser diode 79 generates laser light in accordance with a drive current supplied from the laser modulation control circuit 75. The laser light emitted from the laser diode 79 is applied onto the optical disc 100 via a collimator lens 80, a half-prism 81 and the objective lens 70. Reflection light from the optical disc 100 is guided to a photodetector 84 via the objective lens 70, the half-prism 81, a collecting lens 82 and a cylindrical lens 83.

The photodetector 84 includes, for example, four photodetector cells, and detection signals of these photodetector cells are output to an RF amplifier 85. The RF amplifier 85 processes the signals from the photodetector cells, and generates a focusing error signal FE indicating a deviation from a focal position, a tracking error signal TE indicating a difference between the beam spot center of the laser light and the center of the track, and a reproduction signal which is a total sum signal of the signals of the photodetector cells.

The focusing error signal FE is supplied to a focusing control circuit 87. The focusing control circuit 87 generates a focusing drive (control) signal in accordance with the focusing error signal FE. The focusing drive signal is supplied to the drive coil 71 in the focusing direction. Thus, the position of the PUH 65 is set by control called a focusing servo whereby the minimum spot of the laser light which is given convergence properties by the objective lens 70 incorporated in the PUH 65 moves to coincide with (be just focused on) the recording film of the optical disc 100.

The tracking error signal TE is supplied to a tracking control circuit 88. The tracking control circuit 88 generates a tracking drive signal in accordance with the tracking error signal TE. The tracking drive (control) signal output from the tracking control circuit 88 is supplied to the drive coil 72 in the tracking direction. Thus, the position of the PUH 65 is controlled so that the laser light always traces on the track formed on the optical disc 100, by control called a tracking servo whereby the PUH 65 moves in the radial direction of the optical disc 100.

Such a focusing servo and tracking servo are performed, such that the change of the reflection light from, for example, a recording mark formed on the track of the optical disc 100 in accordance with recording information is reflected in a total sum signal RF of the output signals from the photodetector cells of the photodetector 84. This signal is supplied to a data reproduction circuit 78. The data reproduction circuit 78 reproduces the recording data on the basis of a reproduction clock signal from a PLL circuit 76.

When the objective lens 70 is controlled by the tracking control circuit 88, the position of the feed motor 67, that is, the position of the optical head (PUH) 65 is also controlled by the feed motor control circuit 68 so that the objective lens 70 is located in the vicinity of a predetermined position within the optical head 65.

The spindle motor control circuit 64, the feed motor control circuit 68, a laser control circuit 73, the phase locked loop (PLL) circuit 76, the data reproduction circuit 78, the focusing control circuit 87, the tracking control circuit 88, an error correction circuit 62, etc. are controlled by the main arithmetic processing block (CPU) 90 via a bus 89. The CPU (main arithmetic processing block) 90 controls the overall operation of the recording/reproducing apparatus in accordance with operation commands provided from the host device 94 through the interface circuit 93. Moreover, the CPU 90 uses a random access memory (RAM) 91 as a working area, and performs a predetermined operation in accordance with a control program including a program by the present invention recorded in a read-only memory (ROM) 92 by appropriately referring to a parameter for each individual apparatus recorded in a nonvolatile random access memory. In addition, it goes without saying that the error correction circuit 62 corrects errors in the reproduction signal.

Today, as a method of recording information on a recording medium, that is, an optical disc by the optical disc drive (information recording/reproducing apparatus) as shown in FIG. 1, “sub-nanosecond pulse recording” is coming into practical use which uses a sharp recording pulse of a length smaller than 1 ns to carry out recording with smaller light energy.

The “sub-nanosecond pulse recording” requires performance of the recording pulse in which the rise/fall time of an LD drive current pulse for the laser diode 79 is less than 100 ps.

Furthermore, the “sub-nanosecond pulse recording” satisfies the requirements for the rise time/fall time, but the duty ratio, that is, the ratio of on-time (the ratio of the time in which the LD is turned on to the length of a recording mark) of the laser emission of the “sub-nanosecond pulse recording” is often less than 10%.

Moreover, the interval between one wave (first pulse) and another wave (next pulse) may be equal to or less than 10% in terms of pulse duty, and when known auto power control (APC) for maintaining constant laser power is used, an average value decreases because the output of a monitoring detector is generally temporally averaged output, so that degradation of the signal-to-noise ratio is recognized.

In this context, there has been a demand that the recording energy of pulse laser light used in the sub-nanosecond class pulse recording can be accurately controlled.

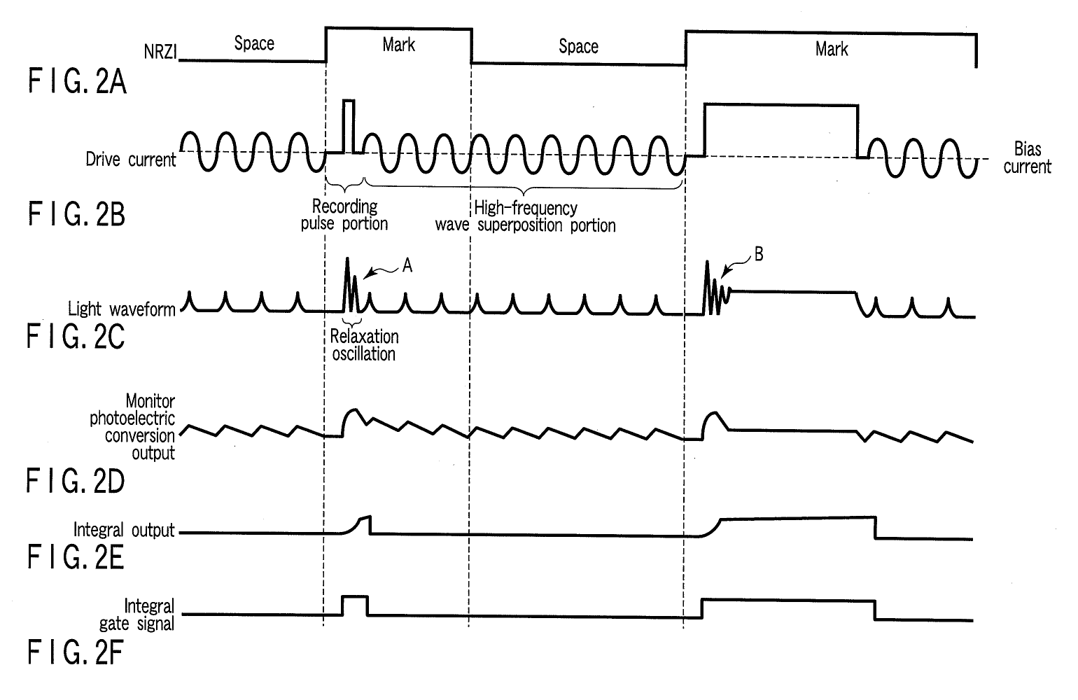

The reason is considered below with FIGS. 2A to 2F why the laser power can not be accurately detected when the above-mentioned sub-nanosecond class pulse recording is carried out in the information recording/reproducing apparatus shown in FIG. 1.

FIGS. 2A to 2F schematically show time-series changes in the strength of laser emission light, its monitor photoelectric conversion element and its integral value.

As shown in FIG. 2C, the laser emission light is a pulse containing a relaxation oscillation as well, and especially in a part where the relaxation oscillation is generated, the half-value width is narrow and about 50 to 100 ps and the width of the whole pulse is small, so that the ratio of the relaxation oscillation part in the energy amount of laser emission (energy amount) is not negligible.

Thus, in order to stabilize the power of the laser emission light (emitted light), it is necessary to detect the total energy of pulses including the relaxation oscillation parts.

However, since a pulse width can be less than 1 ns, the output of the optical disc monitor photoelectric conversion element (PDIC) that is widely used, inexpensive and easily available has a dull waveform as shown in FIG. 2D.

Thus, it is difficult (substantially impossible) for the standard type auto power control (APC) technique to acquire the instantaneous value such as the peak value of the above-mentioned pulse laser.

The one embodiment of the present invention newly applies automatic energy control (AEC) which compares the integral value (proportionate to the energy of emitted light) of the output of the monitor photoelectric conversion element (FM-PD 95) with a reference value to maintain constant emission power of the laser light output from the LD 79. This makes it possible to maintain constant emission laser power even in the recording based on the sub-nanosecond pulse wherein pulsed emissions of laser are performed with a sharp recording pulse of a length smaller than 1 ns and with a low duty ratio of laser light emission in which the emission time of the laser is less than 10% of a mark length of a recording medium (recording on the recording film of the optical disc).

That is, the integration of the output of the monitor photoelectric conversion element (FIG. 2E) for a pulse output period alone using an integral gate signal shown in FIG. 2F is used as an observation amount of the intensity of pulse laser. At the end of the gate signal, a sample-and-hold (S/H) output is provided after the (pre-) integrator so that the integration signal is held, and the output of the S/H is integrated by the post-integrator, thereby achieving AEC operation different from simple averaging.

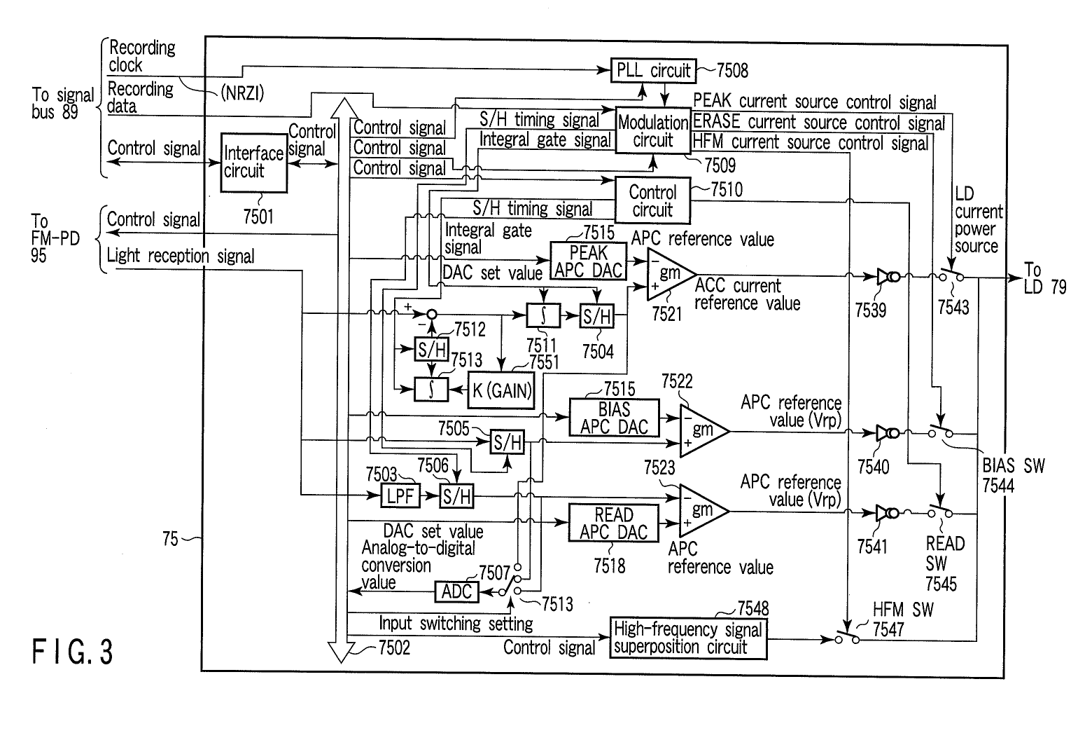

More specifically, as shown in FIG. 3, the laser modulation control circuit 75 is separated into a waveform generating unit for generating a recording waveform from a recording clock and recording data and switching a current source accordingly, an AEC operation unit for controlling the current to the laser diode (LD) 79 so that irradiation power ordered from the CPU 90 is obtained during recording/reproduction, and a control unit for interpreting a control signal from the signal bus 89 and controlling the whole laser modulation control circuit 75.

The waveform generating unit includes a PLL circuit 7508, a modulation circuit 7509 and a high-frequency wave superposition circuit 7548. The PLL circuit 7508 receives a recording clock to generate a timing signal necessary for the modulation circuit 7509. The modulation circuit 7509 interprets the recording data to generate a recording waveform in accordance with a control signal set by the internal bus 7502, and decomposes the recording waveform into current source control signals indicating the on/off of the respective current sources.

The current source control signals are connected to a PEAK SW 7543 and a BIAS SW 7544, respectively. Consequently, the respective current sources are turned on/off, such that the strength of the LD drive current increases or decreases, and the strength of the irradiation power during recording is modulated.

A PEAK SW 7545 is a switch of the current source which is only turned on mainly during reproduction, and is turned on/off by a control circuit 7510 in accordance with a recording/reproduction switching signal contained in the control signal from the signal bus 89. The high-frequency wave superposition circuit 7548 outputs a sinusoidal wave with amplitude and a frequency that are determined by the control signal set by the internal bus 7502 in the range of about 100 MHz to 1 GHz. Moreover, the output current of the high-frequency wave superposition circuit 7548 is controlled by an HFM SW 7547 whose on/off is controlled by the CPU 90 through the internal bus 7502, and a high-frequency current is superposed mainly during reproduction.

In reproduction, the AEC operation unit is substantially equivalent to a circuit which has heretofore been well known as an APC circuit. That is, the AEC operation unit compares, by a comparison amplifier 7522, a light reception signal input from an FM-PD 95 through an LPF 7503 for noise elimination and through a sample-and-hold circuit S/H 7505 for holding the state of reproduction during recording, with an output of a READ APC DAC 7516 in which there has been set READ irradiation power information contained in the control signal input from the CPU 90 via the signal bus 89. Then, the AEC operation unit controls a current source 7540 so that it coincides with the READ irradiation power, and adjusts the LD drive current.

In recording, the light reception signal from the FM-PD 95 in a space portion is input to an integrator 7511. For laser light having a particular (one or a plurality of kinds of) pulse length or for laser light of strength which can provide a particular (one or a plurality of kinds of) recording mark length, the integrator 7511 integrates the output of the FM-PD 95, and controls the strength of the drive current using the integral value as a target value. That is, the integrator 7511 performs integration during the period of the output of the integral gate signal generated by the modulation circuit 7509. The output of the integrator 7511 is input to a sample-and-hold circuit S/H 7504 which holds the value at the end of the integral gate signal. In addition, it goes without saying that the target value may be set by averaging an integration of 2 or more.

Subsequently, the output of the sample-and-hold circuit S/H 7504 is compared with an irradiation power integration reference value contained in the control signal input from the CPU 90 via the signal bus 89, and a power source 7539 is controlled so that the irradiation power at which the PEAK SW 7543 is turned on coincides with the set irradiation power integration reference value.

In addition, there is also a method of performing AEC operation by the CPU 90 instead of the comparison amplifier of the laser modulation control circuit 75.

For example, the CPU 90 inputs the output of the S/H 7504 to an analog-to-digital converter ADC 7507 for analog-to-digital conversion. Then, the CPU 90 acquires its information (the result of the analog-to-digital conversion) through the internal bus 7502 and the signal bus 89, and calculates an LD drive current. The calculated LD drive current value is set in a PEAK APC DAC 7515, and transmitted to the power source 7539 via a comparison amplifier 7521.

On the other hand, the integrator 7511 located after an integrator 7513 integrates the input direct current offset, and the presence or variation of the direct current offset may therefore cause a great output error. Thus, the integrator of the AEC operation unit is preferably provided with a circuit for removing the input direct current offset. An example of this is shown.

As shown in FIG. 3, a circuit including the offset detection (pre-) integrator 7513 detection is provided before the integrator 7511. When the integral gate signal is input to the offset detection integrator 7513, the light reception signal input from the FM-PD 95 is only integrated while the integral gate signal is being supplied from the control circuit 7510 (CPU 90). If not (when the light reception signal is not input), the integral value is initialized to zero.

Subsequently, the output of the integrator 7513 is input to a sample-and-hold circuit S/H 7512 which holds the value at the end of the integral gate signal.

In order to remove the offset, the following sequence is useful:

Before the recording of information on the optical disc 100 or the reproduction of information from the optical disc 100 (mainly during initialization operation after power application),

as step S11,

“the integral gate signal of the integrator (pre-integrator) 7513 is output, and integration is started”, and

as step S12,

the output of the integral gate signal is stopped after a given time has elapsed”,

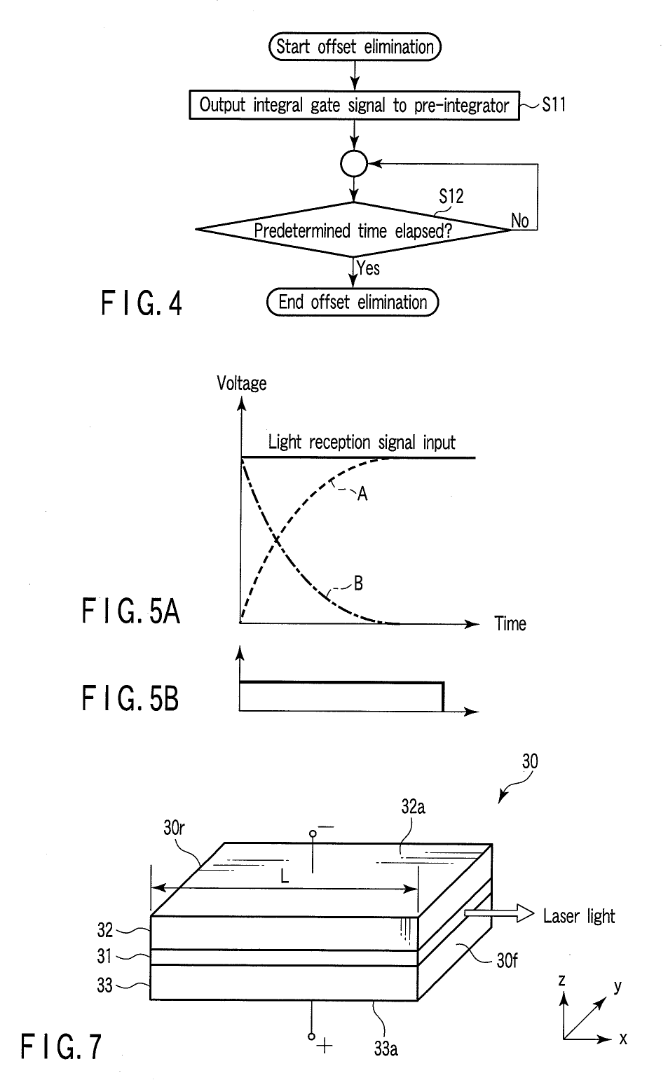

without driving the LD 79 as shown in FIG. 4.

The input to and output of the integrator 7513 at this point are shown in FIG. 5.

In FIG. 5A, a curve A indicates the output of the pre-integrator 7513 as the output of the sample-and-hold circuit 7512, and a curve B indicates the input to a post-integrator 7511. In addition, it goes without saying that the output of the FM-PD 95 is only input to the integrator 7513 while the output of the integral gate signal shown in FIG. 5B (from the control circuit 7510) is being input.

Therefore, after a given time (more than ten times the time constant determined by a gain K [schematically indicated by 7551 in FIG. 3]) has elapsed, the output (input offset) of the light reception signal without driving the LD 79 is stored in the integrator 7513.

In addition, the integrator 7513 can be replaced with an analog-to-digital converter and the S/H 7512 can be replaced with a digital-to-analog converter to achieve similar operation by the operation of the CPU 90.

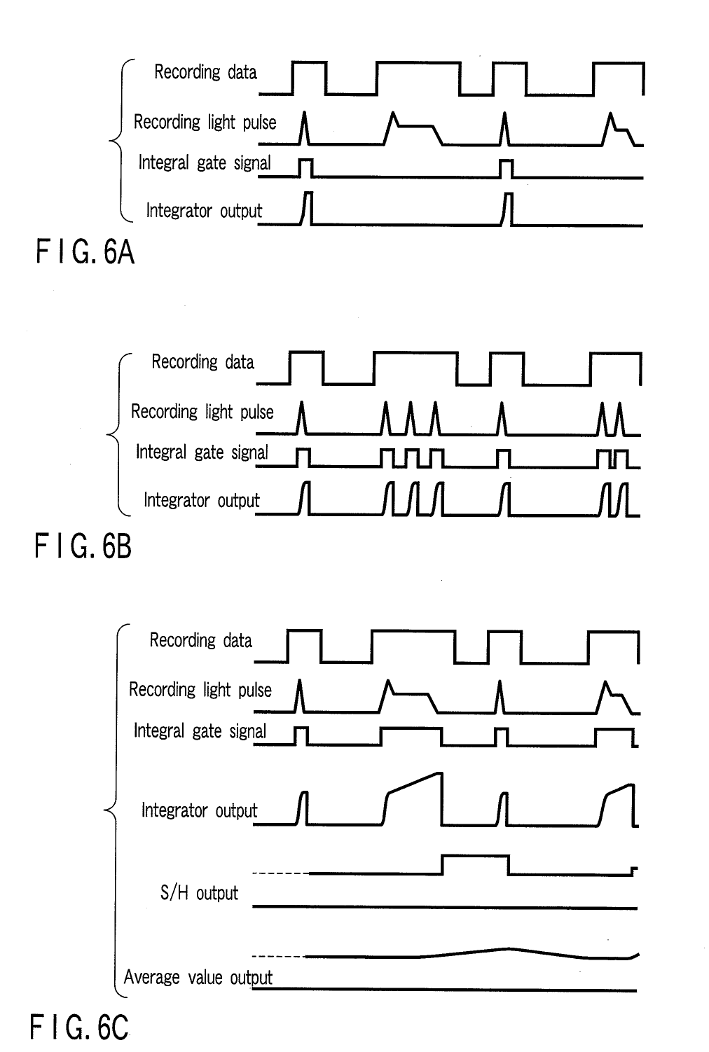

FIGS. 6A to 6C each show an example of the relation between the waveform of emitted pulses and the integral gate signal.

The integral gate signal generated by the modulation circuit 7509 may be output only for a particular mark length so that the integration is performed only for a particular mark length as shown in FIG. 6A. The mark length targeted for integration is set by the CPU 90.

In a recording scheme often used in the case of recording information on the optical disc 100, the strength of a recording pulse in a mark portion (recording mark) is fixed, and the length of the recording pulse is changed to vary the mark length. Thus, a recording pulse current in the mark portion is controlled so that constant irradiation energy at the particular mark length is maintained, and this current is used to change the length of a pulse at other mark lengths so that any mark length can be stably recorded.

On the other hand, as a method of recording information on the optical disc 100, another recording method (recording pulse generating method) is widely used in which the number of times that pulses of single strength and length are output is changed in accordance with the mark length to achieve recording for any mark length, as shown in FIG. 6B.

In such a case, while it is possible to use the integral value for the whole particular mark length as described above, there is also a preferred method which performs integration for each recording pulse and control the recording pulse current so that energy for one recording pulse may be constant.

Still another method is conceived wherein when not all the repetitive pulses are of single strength and length, an integral value is obtained by outputting the integral gate signal only for the single strength and length.

In addition, as shown in FIG. 6C, there is also a preferred method which integrates recording pulse portions regardless of the length of the recording pulse and observe the average value of the integral values, thereby controlling the recording pulse current so that a constant current may be maintained.

This can be easily accomplished by inserting an averaging circuit, for example, a low-pass filter (LPF) between the S/H 7504 and the comparison amplifier 7522 in FIG. 3.

In the recording of information on the optical disc, modulation is performed so that the average length of the recording mark lengths may be substantially constant. Therefore, if the recording pulse current is controlled so that the average energy for the recording pulses may be constant, it is possible to obtain a stable recording pulse.

In addition, it goes without saying that the laser modulation control circuit described above with FIG. 3 serves for a test write in the recording layer of the optical disc and for the reproduction of the recording mark in the optical disc drive (information recording/reproducing apparatus) shown in FIG. 1, thereby doubling as a waveform generating circuit for a write strategy (optimization of a recording waveform (laser)).

In the meantime, in the information recording/reproducing apparatus and an optical head device for use in such apparatus which use sub-nanosecond class laser light generated together with the relaxation oscillation to record information on a recording medium, there is presently one problem of stabilizing the generation of the relaxation oscillation and the recording pulse length (the output of pulse laser light generated together with the relaxation oscillation).

Thus, a method is described below which stably outputs the sub-nanosecond class pulse laser light generated together with the relaxation oscillation.

FIG. 7 is a schematic diagram explaining the configuration (resonator length) of the laser diode.

The laser diode (LD) 79 includes a semiconductor laser chip 30 as schematically shown in FIG. 7 in an unshown housing.

The laser chip 30 is a small block having, for example, a thickness (vertical direction) t of about 0.15 mm, a length (horizontal direction) L of about 0.5 mm, and a breadth (depth direction) d of about 0.2 mm.

The laser chip 30 includes an active layer 31 vertically interposed between first and second claddings 32, 33, and an upper end 32a of one cladding and a lower end 33a of the other cladding serve as a “− (minus)” electrode (32a) and a “+ (plus) electrode (33a)”, respectively.

The materials of the first and second cladding layers 32, 33 are selected so that their refractive indices are, for example, about 5% lower than the refractive index of the active layer 31. Light generated in the active layer 31 proceeds in the active layer 31 while being reflected at the boundary between the upper and lower cladding layers, is gradually amplified during movement between mirror surfaces 30f, 30r, and released as laser light from the mirror surfaces 30f, 30r when amplified to a predetermined level. That is, the laser light is output in an x direction parallel with the direction in which the active layer 31 extends, in the example in FIG. 7. In addition, the distance between the first and second mirror surfaces 30f, 30r is a resonator length L.

In the laser chip 30 shown in FIG. 7, the distance L between the first and second mirror surfaces 30f, 30r is determined depending on a required pulse length of the laser light, and the resonator length L is about 0.8 mm in this example. In addition, the period of the relaxation oscillation described later is about 100 ps in full width at half maximum.

A drive current is supplied to the LD 79 from the laser modulation control circuit (laser drive circuit) 75 shown in FIG. 1, such that the LD 79 emits (oscillates) laser light. In addition, the rise time of the drive current supplied from the laser modulation control circuit 75 to the LD 79 is about 1 ns.

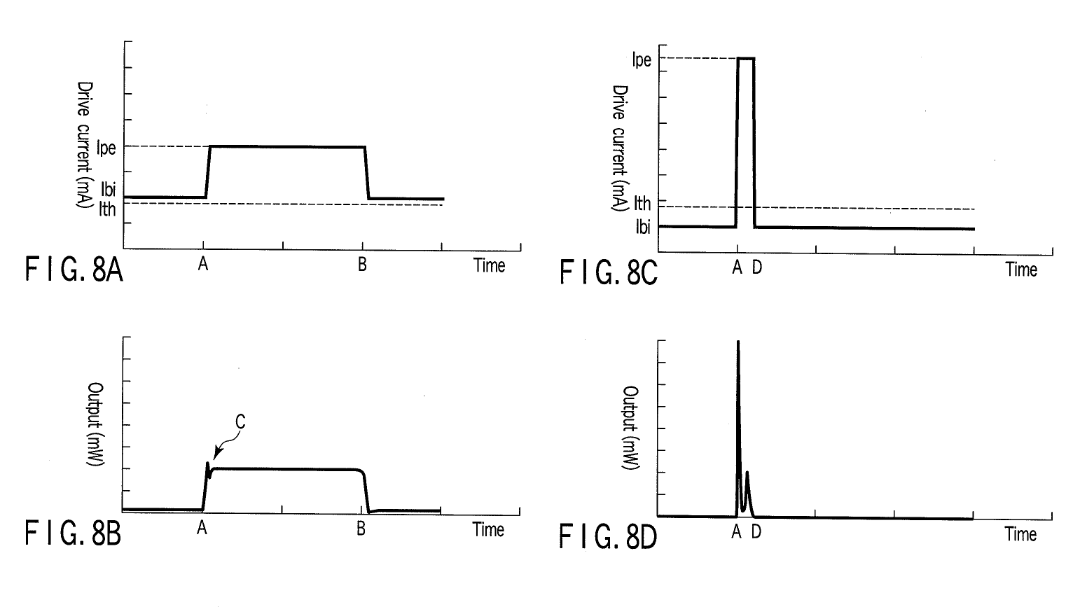

Next described with reference to FIGS. 8A to 8D is a method of generating a recording pulse (laser drive method) which can be used to record information in an unshown recording film of the recording medium, that is, the optical disc 100.

FIGS. 8A and 8B show the relation with the emission (laser output) of the laser light when a general laser drive current is supplied, in the semiconductor laser element. FIG. 8C shows an example of the supply of a laser drive current which can obtain a relaxation oscillation pulse (characteristic laser output) as shown in FIG. 8D.

As shown in FIGS. 8A and 8C, the drive current is controlled at two levels: a bias current Ibi and a peak current Ipe. In addition, the bias current may be further divided and controlled at two or three levels in some cases, but for simplification of explanation, the bias current and the peak current each have one level in the case described here.

When a normal recording pulse is generated, the laser modulation control circuit 75 first generates the bias current Ibi set at a level slightly higher than a threshold current Ith at which the LD 79 starts laser oscillation, and preliminarily drives the LD 79, as shown in FIG. 8A. Then, until the level is dropped to the bias current Ibi at time B, the peak current Ipe for obtaining desired peak power is applied at time A. In this manner, the peak current Ipe is applied between time A and time B, such that the laser output (a change in the strength of laser emission light with time) as shown in FIG. 8B is obtained.

That is, until the time A at which the intensity of the laser drive current is the bias current Ibi, the strength of the emitted light has significantly low power which does not enable the laser light output from the LD 79 to record data on the optical disc 100, but the peak current Ipe is applied so that the strength of the laser light increases to recording power. It is appreciated that the strength of the emitted light is again at low power at and after the time B.

If the strength of the emitted light is observed in more detail, it is seen in FIG. 8B that when the strength is increased to the recording power at the time A, the strength instantaneously increases and then decreases before it stabilizes at steady recording power (an arrow c portion in FIG. 8B). This is attributed to the relaxation oscillation of the LD 79, and this relaxation oscillation is controlled to the minimum in normal recording pulse generation.

The relaxation oscillation is a relaxation oscillation phenomenon which occurs when the laser drive current rapidly increases from a certain level to a fixed level far exceeding the threshold current in the semiconductor laser (LD 79) as described above.

In addition, the relaxation oscillation decreases every time the oscillation is repeated, and eventually settles down.

In the optical recording apparatus of the present invention, this relaxation oscillation is actively utilized for recording.

That is, although the generation of the relaxation oscillation should originally be inhibited, the present invention intends to “stably” obtain a sharp recording pulse having a short length by use of the characteristics of the relaxation oscillation: “a short pulse length” and “an energy amount (an integral value of laser power as an optical output) which may be able to change the recording film of the optical disc 100 to a recording level”.

As shown in FIG. 8C, when a drive current with a predetermined characteristic is supplied to the LD 79 from the laser modulation control circuit 75, oscillation is involved as seen in FIG. 8D, but a laser output with a high peak level is obtained for a slight period of time.

More specifically, the bias current Ibi set at a level lower than the threshold current Ith is supplied to the LD 79. Further, with predetermined timing, that is, at the time A, the drive current is rapidly raised to the peak current level Ipe at a rise time earlier than in the normal recording pulse generation. Then, the drive current is returned to the bias current Ibi at time D after the passage of a nanosecond-level slight moment shorter than in the normal recording pulse generation.

In this case, a laser output (a change in the strength of laser emission light with time) is obtained, as shown in FIG. 8D.

That is, in FIG. 8D, the LD 79 has not started the laser oscillation until the time A at which driving is carried out by the bias current Ibi smaller than the threshold current Ith, but this is a negligible level, and there is only light emission of a light emitting diode. Then, a current is rapidly applied at the time A, such that the relaxation oscillation is caused and the strength of the emitted light rapidly increases.

Subsequently, the amplitude of the relaxation oscillation gradually converges to a steady level, but a predetermined time, that is, time C is set, and then the drive current is set to the Ibi smaller than the threshold current Ith, such that laser light having a certain energy amount is obtained. In addition, as apparent from FIG. 8C and FIG. 8D, the time C is determined to be timing whereby a second period pulse of the relaxation oscillation is generated.

Thus, the pulse generated by the relaxation oscillation is characterized in that the strength of the emitted light increases in a much shorter time than in the normal recoding pulse and that the strength of the emitted light decreases at a certain period which is determined by the structure of the semiconductor laser. Therefore, the use of the pulse generated by the relaxation oscillation for the recording pulse makes it possible to obtain a short pulse having short rise and fall times and having a high peak strength which can not be obtained by the normal recoding pulse.

Meanwhile, it is known that the period of the relaxation oscillation is associated with the resonator length of the laser chip of the semiconductor laser element (LD) described with FIG. 7.

As a relation known in general, the following relation exists between the resonator length L of the LD and a relaxation oscillation period T:

T=k×{2nL/c} (1)

where k is a constant number, n is the refractive index of the active layer of the semiconductor laser, and c is the velocity of light (3.0×10⁸ (m/s)).

Therefore, the resonator length of the laser chip is in proportion to the relaxation oscillation period and thus to the width of a sharp pulse generated by the relaxation oscillation. The resonator length may be increased when the pulse width of the relaxation oscillation should be increased, while the resonator length may be decreased when the pulse width of the relaxation oscillation should be decreased.

Briefly described below is a method of controlling the resonator length of the laser chip to set an arbitrary width of the relaxation oscillation pulse generated by the relaxation oscillation.

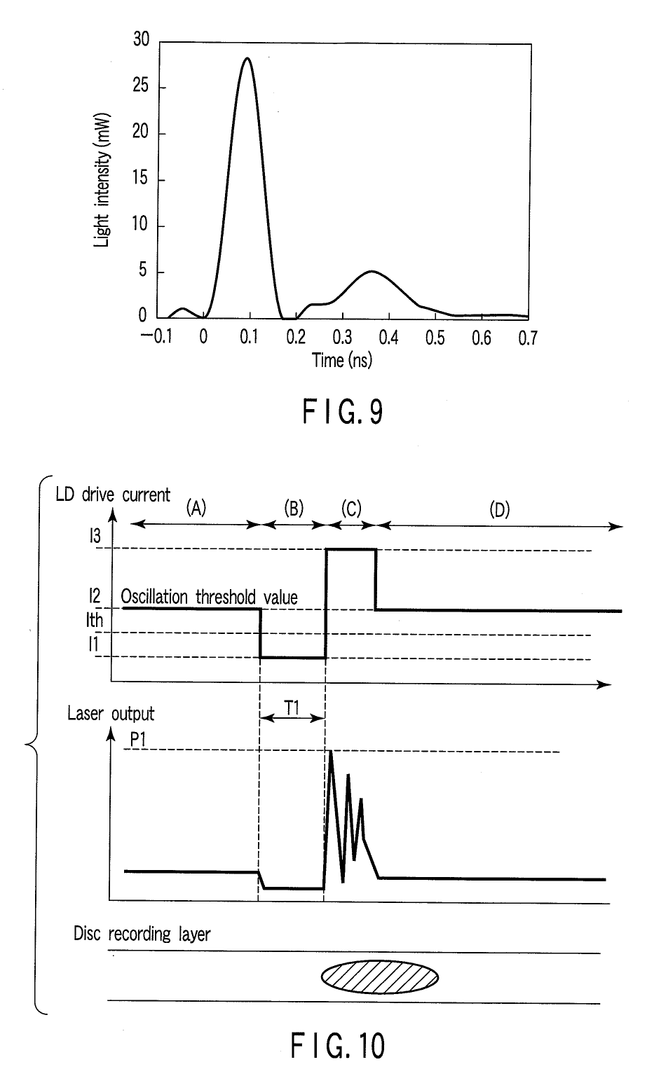

FIG. 9 shows a measurement of a relaxation oscillation waveform produced by semiconductor laser having a resonator length of 650 μm.

It is understood that a relaxation oscillation pulse width (FWHM) Wr is about 81 ps in full width at half maximum.

Since the resonator length of the laser chip 30 of the LD 79 is in proportion to the relaxation oscillation pulse width as described above, the following relation is obtained as a conversion equation for the resonator length Lt of the laser chip 30 and the obtained relaxation oscillation pulse width (FWHM) Wr:

Wr(ps)=L(μm)/8.0(μm/ps) (2).

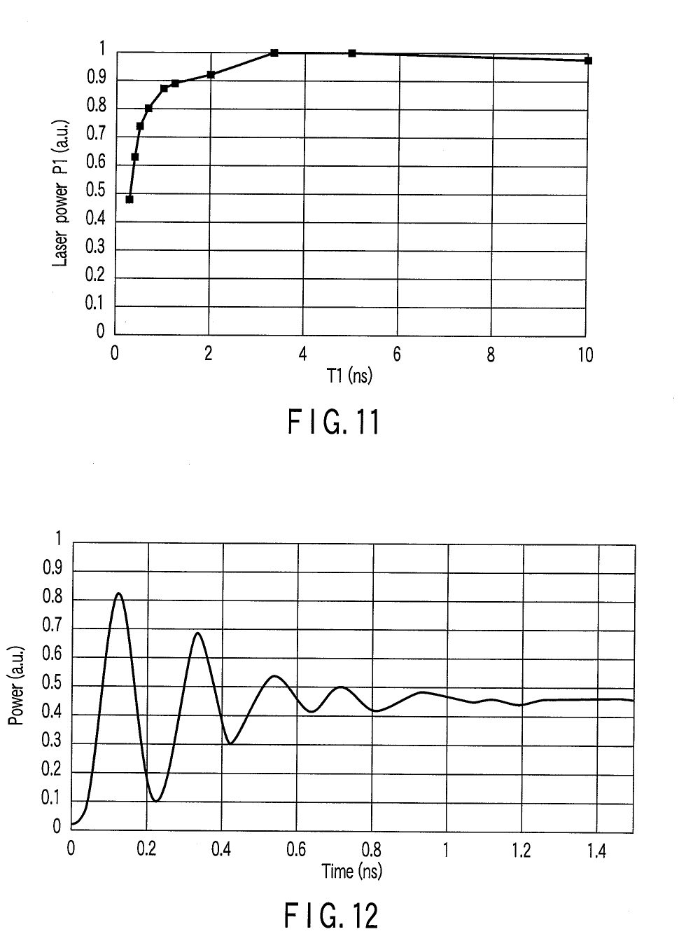

FIG. 10 shows the temporal development of the laser drive current supplied from the laser modulation control circuit 75 to the laser element (LD) 79, the waveform of laser emitted from the LD 79, and the shape of a mark (recording mark) formed in the recording film of the optical disc 100 in accordance with the output laser waveform.

In FIG. 10, in a section of a region (A) where the collection point of the laser light on the recording film of the optical disc 100 is located at a position at which no recording mark is to be formed, the power of the laser light emitted from the LD 79 is controlled to reproduction power used for reproducing information from the optical disc 100. That is, the LD 79 is supplied with a drive current of I2 larger than the Ith which is a threshold value of the drive current which can oscillate laser.

Furthermore, in a section (C), the LD 79 is supplied with a laser drive current of I3 larger than I2, and relaxation oscillation pulse laser light whose maximum value reaches P1 is output.

In addition, during the predetermined time T1 immediately before the region (C) where the relaxation oscillation pulse light is output, that is, in the region (B), the LD 79 is supplied with the laser drive current of I1 smaller than the threshold value Ith.

Moreover, the intensity of the laser drive current after the end of the relaxation oscillation, that is, in a region (D) is again the above-mentioned I2 larger than the threshold value Ith.

That is, in the present invention which records information on the optical disc 100 using the sharp pulse laser obtained by the relaxation oscillation, time-average power of the laser light applied during recording is smaller than the laser power (production power) necessary to reproduce information recorded in the optical disc 100, and average laser power emitted from the laser is varied when recording is started immediately after information is reproduced from the optical disc 100.

Due to the variation of the average laser power, the temperature of the LD 79 changes, and the threshold current of the LD 79 also varies.

The variation of the threshold value changes the laser strength before and after the temperature change even when the LD 79 is driven by the same current. It is therefore desirable that such a change of the threshold value be not made in order to record a satisfactory mark in the recording film of the optical disc 100.

To avoid such a problem, it is desirable that the average power of the laser in reproduction is substantially equal to the average power of the laser in recording. In addition, regarding the average powers of the laser in reproduction and recording, it has been found out that, for example, first average power (A) used for reproduction and second average power (B) used for recording are at such degrees that can substantially neglect the effects of the temperature change in the following range:

0.8<A/B<1.2.

FIG. 11 shows the relation between the time T1 for setting the current value in drive time supplied to LD (laser element) to I1 and maximum strength P1 of the relaxation oscillation.

As has already been explained, the relaxation oscillation is a relaxation oscillation phenomenon which occurs when the drive current rapidly increases from a certain level to a fixed level far exceeding the threshold current in the semiconductor laser (oscillation system), so that the pulse width (recording pulse length) is required to be stable in order to use the relaxation oscillation as a recording pulse. In addition, it has been found out that the maximum power P1 of the laser generated by the relaxation oscillation is low when the time T1 is short and that P1 increases up to a certain level as T1 increases. Moreover, although P1 converges later, laser strength after the convergence of the relaxation oscillation is 0.45×P1 in the present embodiment.

It is therefore understood that when the mark is recorded using the relaxation oscillation, the period of T1 in which P1 is valued at 90% of the value of saturation is desirably 1 ns or more. It has been further proved that the power is substantially equal to the saturation power if T1 is 3 ns or more and that there is almost no effect on the laser output during the period of T1 with higher power. It is therefore more desirable that T1 is 3 ns or more.

On the other hand, a rise time Tr and fall time Tf of the current emitted from the laser modulation control circuit 75 to the LD 79 (these are times required for a variation from 10% to 90% of the maximum current flowing in the LD 79) are both 150 ps in consideration of all of the capacities of the LD 79, the laser modulation control circuit 75 and unshown wiring lines extending from the laser modulation control circuit 75 to the LD 79.

In addition, when the rise time is slow, a longer time is taken from the point where a current value equal to or less than the threshold value is set in the laser modulation control circuit 75 to the point where the value of the current actually flowing in the LD 79 becomes equal to or less than the threshold value. This time is substantially equal to the fall time Tf, so that preparing a pre-off pulse (a pulse which indicates the start of the fall of T1) at an interval of Tf+1.25 ns (1250 ps) or more is useful in order to generate relaxation oscillation of suitable intensity (the pre-off pulse is necessary). That is, if Tf is 150 ps, T1 is preferably 1400 ps (1.4 ns) or more.

FIG. 12 is a schematic diagram explaining the end timing of a recording pulse induced by the section (C) in FIG. 10, that is, by the relaxation oscillation.

As shown in FIG. 12, when the resonator length of the laser chip 30 of the LD 79 is 800 μm, time for convergence to 0.45×P1 is about 1 ns (1.5 ns even when the range in FIG. 11 is defined as the relaxation oscillation) if the peak power P1 is “1”.

Thus, when the resonator length is 800 μm, the recording pulse length, that is, the length of the section (C) in FIG. 10 has only to be shorter than 1500 ps (1.5 ns).

As described above, in the recording using the relaxation oscillation, the width of the sharp recording laser pulse induced by the relaxation oscillation is 1.5 ns or less which is shorter than the laser output produced by the supply of a general drive current, such that laser light with great peak output P1 is emitted.

Consequently, in the optical disc in which the recording mark is recorded by thermal recording (the amount of heat energy supplied as laser light), the recording mark can be smaller in the recording method using the relaxation oscillation than in the case where the mark is recorded by the applying laser for a long time with normal low power.

That is, the use of the recording pulse obtained by the relaxation oscillation allows a shorter time for the application of the laser light to the recording film of the optical disc 100 than in the case of using laser light without the relaxation oscillation, thereby reducing the amount of heat diffused from the place in the recording layer of the optical disc where the laser is applied to other places.

This also shows that average laser power required as the recording pulse can be smaller than in the conventional recording methods.

In addition, in the “sub-nanosecond pulse recording”, when the relation between data (NRZI) recorded using the sub-nanosecond pulse recording of the present embodiment and a corresponding drive current waveform of the laser element is applied, pulse laser light is output in which the emission time of the laser is less than 10% (1% to 10%) of a mark length which is one of the recording mark array to be recorded on the optical disc (information recording medium) 100, so that the average value of the power of the laser light during recording may be less than that of the power for reproduction.

On the other hand, the difference of reflectance between a mark portion and a space portion may be small depending on the material of the optical disc as a recording medium. Therefore, there has been developed a recording medium in which the reflectance of the mark portion or the space portion is decreased to about 2% when information is recorded in order to improve apparent contrast.

When the recording method based on the sub-nanosecond pulse is applied to the recording of information on such a recording medium, an average amount of light returning to the photodetector in the optical head during recording is significantly small. Thus, the quality level of a detected signal is significantly degraded, and it may be impossible to perform the operation (focusing/tracking servo) of obtaining an error signal from the detected signal to fix the objective lens to a predetermined position in the recording layer.

Thus, the inventor has proposed the optical disc apparatus shown in FIG. 1 as an information recording/reproducing apparatus which increases the average amount of light by the superposition of a high-frequency signal between recording pulses to perform recording based on the sub-nanosecond pulse and which can also normally perform the focusing/tracking servo.

However, in the case of generating a recording pulse using the sub-nanosecond pulse, when the high-frequency signal is superposed between the recording pulses, there is a risk that an unnecessary (unintended) relaxation oscillation may be generated in the semiconductor laser (LD) 79 if there is a great difference between the potential (or current) level of the edge of the recording pulse and the potential (or current) level of the continuous high-frequency signal. When there is the unnecessary relaxation oscillation, the laser light becomes uneven, leading to a disturbed recording mark and a disturbed reproduction signal.

Thus, the high-frequency signal is superposed between the recording pulses to prevent the generation of the unnecessary relaxation oscillation.

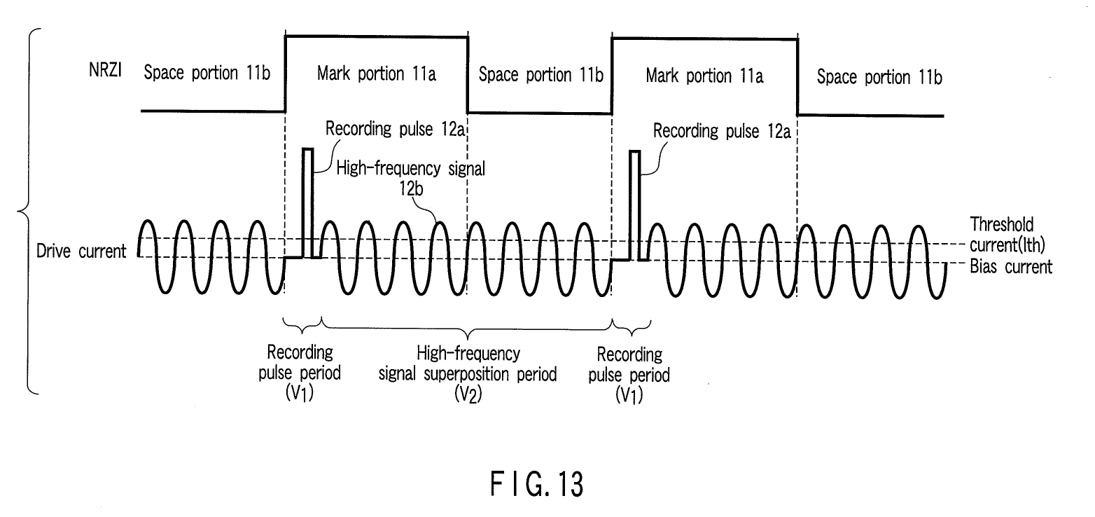

In one example of this shown in FIG. 13, when data (NRZI) to be recorded and a drive current waveform of the corresponding semiconductor laser (LD 79) contain a recording pulse period (V1) and a high-frequency signal superposition period (V2), a recording pulse 12a is output one or a plurality of times in a mark portion 11a. Further, other than the recording pulse period (V1), a high-frequency signal 12b is output independently of the mark portion 11a and a space portion 11b. Thus, the average strength of the semiconductor laser is maintained.

Owing to the drive current in the recording pulse period (V1), the LD 79 emits stronger light in the recording pulse period (V1) than in the high-frequency signal superposition period (V2). Due to this strong light emission, the recording layer of the optical disc thermally changes, and a recording mark is formed. The drive current in the high-frequency signal superposition period (V2) has such a value that the average light strength of the laser diode does not thermally or optically change the recording layer of the optical disc.

This light strength is often the strength at which information is read from the recording layer of the optical disc. The level of the threshold current shown in FIG. 13 is a level which serves as a boundary between the start and stopping of the light emission of the laser diode. In order to obtain the relaxation oscillation, the laser diode requires a recording pulse which rapidly changes from a level equal to or less than this threshold current level. Therefore, for recording, it is necessary to once decrease the current to a current equal to or less than the threshold current from a current value for obtaining light strength to read information of the recording layer of the optical disc, and then obtain the rapidly changing recording pulse 12a. In a recording mode, the light strength for reading information from the optical disc is necessary when, for example, an address is read. In addition, a period may be provided between the recording pulse 12a and the high-frequency signal 12b so that the drive current is fixed as a bias current.

In the above description, one kind of relation between the drive current of the laser diode and the NRZI waveform has been shown as in FIG. 13 for clarity of explanation. However, various waveforms are used as the NRZI waveform in accordance with channel data. Moreover, in accordance with this NRZI waveform, a recording pulse for effectively forming the mark portion and the space portion in the recording medium is generated.

As described above, in the recording using the sub-nanosecond pulse, a state called the relaxation oscillation is created in the laser diode to obtain light with high emission strength. Therefore, light emission sustains with attenuating emission strength even after the drive current has been stopped from the recording pulse 12a. Stable recording is enabled by providing a bias period with a constant drive current after the recording pulse 12a until the relaxation oscillation settles down. In addition, although not shown, it is readily appreciated that a high-frequency superposition circuit may be added to the laser modulation control circuit (laser drive circuit) 75 shown in FIG. 1 and FIG. 3 for the recording pulse 12a so that the high-frequency signal 12b can be output.

It is readily appreciated from the above description that the automatic energy control (AEC) which is the embodiment of this invention is used to maintain constant emission power (the energy amount of laser light applied to the recording film), such that it is possible to stably output the sub-nanosecond class laser light generated together with the relaxation oscillation. In addition, the AEC compares the integral value of the output of the monitor photoelectric conversion element (proportionate to the energy of emitted light) with a reference value, and hardly produces a cost increase.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head device comprising:
a laser element configured to output laser light;
an optical system configured to guide the light from the laser element to a recording medium;
a photodetector configured to receive a light component separated from the laser light from the laser element by the optical system and to output a signal corresponding to the strength of the light component;
an integrator configured to integrate the signal from the photodetector for a predetermined time; and
a controller configured to control an amount of a laser drive current supplied to the laser element in order to output a laser output based on an output signal from the integrator.

2. The optical head device of claim 1, wherein a level of the laser light output from the laser element is controlled by an amount of the laser drive current into the laser element.

3. The optical head device of claim 2, wherein the controller is configured to control the amount of the laser drive current supplied to the laser element in accordance with a target value that is an integral output from the integrator.

4. The optical head device of claim 2, wherein the control circuit is configured to control the amount of the laser drive current supplied to the laser element in accordance with a target value, the target value being an average of a plurality of integral values from the integrator.

5. An optical head device comprising:
a laser element configured to output laser light;
an optical system configured to guide the light from the laser element to a recording medium;
a photodetector configured to receive a light component separated from the laser light from the laser element by the optical system and to output a signal corresponding to the strength of the light component;
a first integrator configured to integrate the signal from the photodetector for a predetermined time;
a filter configured to cancel out a direct current component from the signal from the photodetector to the first integrator; and
a controller configured to control an amount of a laser drive current supplied to the laser element in order to output a laser output based on an output signal from the first integrator.

6. The optical head device of claim 5, wherein the filter comprises a second integrator provided before the first integrator, and a sample-and-hold circuit configured to hold an output of the second integrator for a predetermined time.

7. The optical head device of claim 6, wherein the filter further comprises an integral gate circuit configured to set a time of inputting the output of the second integrator to the first integrator.

8. An information recording/reproducing apparatus comprising:
an optical head device; the optical head device comprising:
a laser element configured to output laser light;
an optical system configured to guide the light from the laser element to a recording medium;
a photodetector configured to receive a light component separated from the laser light from the laser element by the optical system and to output a signal corresponding to the strength of the light component;
an integrator configured to integrate the signal from the photodetector for a predetermined time; and
a controller configured to control an amount of a laser drive current supplied to the laser element in order to output a sub-nanosecond order pulse laser output based on an output signal from the integrator;
a moving mechanism configured to move the optical head device in a radial direction of the recording medium;
a medium rotator configured to rotate the recording medium at a predetermined velocity; and
a signal reproducing system configured to reproduce information recorded in the recording medium from the signal from the photodetector.

9. An information recording/reproducing apparatus comprising:
an optical head device; the optical head device comprising:
a laser element configured to output laser light;
an optical system configured to guide the light from the laser element to a recording medium;
a photodetector configured to receive a light component separated from the laser light from the laser element by the optical system and to output a signal corresponding to the strength of the light component;
an integrator configured to integrate the signal from the photodetector for a predetermined time;
a filter configured to cancel out a direct current component from the signal from the photodetector to the integrator; and
a controller configured to control an amount of a laser drive current supplied to the laser element in order to output a sub-nanosecond order laser output based on an output signal from the integrator;
a motor controller configured to move the optical head device in a radial direction of the recording medium;
a medium rotator configured to rotates the recording medium at a predetermined velocity; and
a signal reproducing system configured to reproduce information recorded in the recording medium from the signal from the photo detector.

10. A laser drive circuit comprising:
a photodetector configured to receive part of laser light emitted from a laser element to a recording medium independently of reflected laser light from the recording medium, and to output a signal corresponding to the strength of the part of the laser light;
an integrator configured to integrate the signal from the photodetector for a predetermined time; and
a controller configured to control an amount of a laser drive current supplied to the laser element in order to output a sub-nanosecond order pulse laser output based on the output from the integrator.

11. The laser drive circuit of claim 10, wherein the controller is configured to supply the laser element with laser drive current, an amount of the laser drive current being larger than a threshold amount permitting laser oscillation while outputting the pulse laser output, and the amount of the laser drive current being smaller than the threshold amount for a predetermined time before outputting the pulse laser output.
